(19) United States
(12) Patent Application Publication
(10) Pub. No.: US 2008/0197075 A1
(43) Pub. Date: Aug. 21, 2008

(54) REMOVING MERCURY AND OTHER HEAVY METALS FROM INDUSTRIAL WASTEWATER

(76) Inventors: Deepak A. Musale, Aurora, IL (US); Jitendra T. Shah, Naperville, IL (US)

Correspondence Address: Peter A. DiMattia;Patent and Licensing Department, Nalco Company, 1601 West Diehl Road, Naperville, IL, 60563-1198, US

(21) Appl. No.: 12/107,108

(22) Filed: Apr. 22, 2008

Related U.S. Application Data
(63) Continuation-in-part of application No. 11/516,843, filed on Sep. 7, 2006.

(51) Int. Cl. B01D 65/02; C02F 1/44

(52) U.S. Cl. 210/636; 210/652

(57) ABSTRACT

A method of removing one or more heavy metals including mercury from industrial wastewater by use of a filtration and/or a solid-liquid separation system by use of a water soluble ethylene dichloride ammonia polymer.

### CROSS REFERENCE TO RELATED APPLICATION

This application is a continuation-in-part of U.S. Ser. No. 11/516,843, filed on Sep. 7, 2006, which is herein incorporated by reference.

### FIELD OF THE INVENTION

This invention pertains to a method of removing mercury and other heavy metals from industrial wastewater via the use of a filtration system and other separation systems.

### BACKGROUND

Regulations for controlling the mercury concentration in the effluent from industrial processes have tightened because of concerns over mercury levels in lakes and reservoirs.

Coal fired power plants and waste incinerators are a major source of mercury and other pollutants. Specifically, wastewater from power plant including flue gas desulfurization system (wet FGD), are areas of concern for these power plant and incinerator processes. In particular, the treatment of FGD wastewater has always been a challenge with the presence of mercury, selenium and arsenic in the purge stream.

A methodology to address these problems is therefore desired by the industry.

### SUMMARY OF THE INVENTION

The present invention provides for a method of removing one or more heavy metals including mercury from industrial wastewater by use of a filtration process comprising the following steps: (a) maintaining the pH of said industrial wastewater to achieve at least the hydroxide precipitation of mercury; (b) adding an effective amount of a water soluble ethylene dichloride ammonia polymer having a molecular weight of from about 500 to about 10,000 daltons that contains from about 5 to about 50 mole percent of dithiocarbamate salt groups to react with at least mercury in said industrial wastewater; (c) passing said treated industrial wastewater through a filter device excluding a UF or MF membrane; and (d) optionally back-flushing said filter device to remove solids from the filter device.

The present invention also provides for a method of removing one or more heavy metals including mercury from industrial wastewater by use of a solid-liquid separation process comprising the following steps: (a) maintaining the pH of said industrial wastewater to achieve at least the hydroxide precipitation of mercury; (b) adding an effective amount of a water soluble ethylene dichloride ammonia polymer having a molecular weight of from about 500 to about 10,000 daltons that contain from about 5 to about 50 mole percent of dithiocarbamate salt groups to react with at least mercury in said industrial wastewater; and (c) passing said treated industrial wastewater through a solid liquid-separation device excluding a UF or MF membrane.

### BRIEF DESCRIPTION OF THE DRAWING

FIG. 1 illustrates a general process scheme for processing industrial wastewater containing mercury, which includes a filter device, an optional ultrafiltration (UF) or microfiltration (MF) membrane as well as an additional membrane for further processing of the filtrate from said filter device.

### DETAILED DESCRIPTION OF THE INVENTION

### Definitions of Terms

“UF” means ultrafiltration.

“MF” means microfiltration.

“ppt” means parts per trillion

“Chelant scavengers” means compounds that are capable of complexing with chelants. These scavengers are usually, but are not limited to, the salt form.

“Polymeric Chelant” means a polymeric molecule that reacts and/or complexes with heavy metals.

“Amphoteric polymer” means a polymer derived from both cationic monomers and anionic monomers, and, possibly, other non-ionic monomer(s). Amphoteric polymers can have a net positive or negative charge. The amphoteric polymer may also be derived from zwitterionic monomers and cationic or anionic monomers and possibly nonionic monomers. The amphoteric polymer is water soluble.

“Cationic polymer” means a polymer having an overall positive charge. The cationic polymers of this invention are prepared by polymerizing one or more cationic monomers, by copolymerizing one or more nonionic monomers and one or more cationic monomers, by condensing epichlorohydrin and a diamine or polyamine or condensing ethylenedichloride and ammonia or formaldehyde and an amine salt. The cationic polymer is water soluble.

“Zwitterionic polymer” means a polymer composed from zwitterionic monomers and, possibly, other non-ionic monomer(s). In zwitterionic polymers, all the polymer chains and segments within those chains are rigorously electrically neutral. Therefore, zwitterionic polymers represent a subset of amphoteric polymers, necessarily maintaining charge neutrality across all polymer chains and segments because both anionic charge and cationic charge are introduced within the same zwitterionic monomer. The zwitterionic polymer is water-soluble.

“Anionic polymer” means a polymer having an overall negative charge. The anionic polymers of this invention are prepared by polymerizing one or more anionic monomers or by copolymerizing one or more non-ionic monomers and one or more anionic monomers. The anionic polymer is water-soluble.

### PREFERRED EMBODIMENTS

As stated above, the invention provides for a method of removing one or more heavy metals including mercury by use of a filtration device and/or other types of solid-liquid separation devices.

If chelants are present in the industrial wastewater, then pH needs to be adjusted to de-complex the mercury from the chelant in the industrial wastewater, and there needs to be a subsequent or simultaneous addition of one or more chelant scavengers. Chelants will usually de-complex from a metal (e.g. mercury) when the pH is less than four, preferably the pH is adjusted and/or maintained in the range of from about 3 to about 4.

In one embodiment, the chelant scavengers contain Ca or Mg or Al or Fe.

In another embodiment, the chelant scavenger containing Fe is selected from the group consisting of: ferrous chloride; ferrous sulfate; ferric chloride; ferric sulfate; or a combination thereof.

Various types and amounts of acids and bases may be utilized to adjust the pH of industrial wastewater.

In one embodiment, the base may be selected from the group consisting of magnesium and calcium salts such as chlorides and hydroxides.

In another embodiment, the base is selected from the group consisting of hydroxides of sodium, potassium, ammonium and a combination thereof.

Various iron compounds and dosages may be utilized to further treat the pH adjusted industrial wastewater. In yet another embodiment, the dosages of iron compounds used may be from about 100 ppm to about 10,000 ppm based upon actives, depending upon the level of chelant present in the industrial wastewater.

One step of removing mercury and other heavy metals from industrial wastewater is the step of: maintaining the pH of the system to achieve hydroxide precipitation of mercury in said industrial wastewater. Maintaining may for e.g. require leaving the system alone or adjusting the pH of the industrial wastewater. Hydroxide precipitation occurs when the wastewater pH is such that the metal hydroxide has a minimum solubility.

In a preferred embodiment the pH of the industrial wastewater is maintained, e.g. by adjusting, to a pH of about 5 to about 10. Any base that allows for pH adjustment to the desired range is envisioned. For example, the base selected for pH adjustment is selected from the group consisting of hydroxides of: sodium, potassium, magnesium, calcium, ammonium and a combination thereof.

In one embodiment, the industrial wastewater containing mercury is selected from an industrial process selected from the group consisting of: semiconductor manufacturing; circuit board manufacturing; metal finishing; metal plating; power generation; refining; automotive; and a combination thereof.

Another step that needs to be taken for heavy metal removal from industrial wastewater is the step of adding an effective amount of water-soluble ethylene dichloride ammonia polymers.

In one embodiment, the ethylene dichloride ammonia polymers are prepared by the reaction of ethylene dichloride and ammonia. The starting ethylene dichloride ammonia polymers generally have a molecular weight range of 500-100,000. In a preferred embodiment the molecular weight is 1,500 to 10,000, with a most preferred molecular weight range being 1,500-5,000. A typical reaction for producing these polymers is described in U.S. Pat. No. 5,346,627, which is herein incorporated by reference. The polymers may also be obtained from Nalco Company, 1601 West Diehl Road, Naperville, Ill.

In one embodiment, the effective amount of water-soluble ethylene dichloride-ammonia polymer added to the industrial wastewater is from 10 ppm to about 1,000 ppm based on active solids. Other amounts, for e.g. up to about 10,000 ppm based upon actives may be utilized.

In another embodiment, the water-soluble ethylene dichloride ammonia polymer added to the industrial wastewater has a molecular weight of about 2,000 to about 2,000,000 daltons.

In another embodiment, the treated industrial wastewater that passes through a filtration device may be further processed through UF or MF membrane and then through additional membranes.

In yet a further embodiment, the additional membrane is either a reverse osmosis membrane or a nanofiltration membrane.

The filtration device utilized to process industrial wastewater containing mercury may have various types of physical and chemical parameters.

With respect to physical parameters, in one embodiment, the filtration device has a separation rating of 0.001 μm to 10 μm. Preferably, in one embodiment, the filtration device has a separation rating of 0.1 μm to 10 μm.

In another embodiment, the filtration device is selected from the group consisting of: sand filter, multimedia filter, cartridge filter, drum filter with a coated media (e.g. diatomaceous earth), bag filter and a combination thereof.

In another embodiment, the filter device is coarse. One of ordinary skill in the art would understand the meaning of coarse in the context of separation processes.

In one embodiment, the UF or MF pore size is similar or smaller than that of the filtration device when the UF or MF membranes are used after filtration device.

With respect to chemical parameters, in one embodiment, the media used in media filters may be sand, anthracite, granite and a combination thereof. There are other physical and chemical parameters of the filtration devices that may be implemented for the claimed invention.

Various types of solids-liquid separation devices may be used to carry out this invention.

In one embodiment, the solid-liquid separation device is selected from the group consisting of: a centrifuge, a lamellae plate clarifier, or a combination thereof.

After the industrial wastewater is treated with the water-soluble ethylene dichloride ammonia polymer, the wastewater may be further treated with one or more water-soluble polymers to further increase the particle size and enhance the filter/separation productivity and mercury removal.

In one embodiment, the water-soluble polymers are selected from the group consisting of: amphoteric polymers; cationic polymers; anionic polymers; and zwitterionic polymers.

In another embodiment, the water soluble polymers have a molecular weight from 100,000 to about 10,000,000 daltons.

In another embodiment, the amphoteric polymers are selected from the group consisting of: dimethylaminoethyl acrylate methyl chloride quaternary salt (DMAEA.MCQ)/acrylic acid copolymer, diallyldimethylammonium chloride/acrylic acid copolymer, dimethylaminoethyl acrylate methyl chloride salt/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer and DMAEA.MCQ/Acrylic acid/N,N-dimethyl-N-methacrylamidopropyl-N-(3-sulfopropyl)-ammonium betaine terpolymer.

In another embodiment, the dosage of the amphoteric polymers is from about 1 ppm to about 2000 ppm of active solids.

In another embodiment, the amphoteric polymers have a molecular weight of about 5,000 to about 2,000,000 daltons.

In another embodiment, the amphoteric polymers have a cationic charge equivalent to anionic mole charge equivalent ratio of about 3.0:7.0 to about 9.8:0.2.

In another embodiment, the cationic polymers are selected from the group consisting of: polydiallyldimethylammonium chloride (polyDADMAC); polyethyleneimine; polyepiamine; polyepiamine crosslinked with ammonia or ethylenediamine; condensation polymer of ethylenedichloride and ammonia; condensation polymer of triethanolamine and tall oil fatty acid; poly(dimethylaminoethylmethacrylate sulfuric acid salt); and poly(dimethylaminoethylacrylate methyl chloride quaternary salt).

In another embodiment, the cationic polymers are copolymers of acrylamide (AcAm) and one or more cationic monomers selected from the group consisting of: diallyldimethylammonium chloride; dimethylaminoethylacrylate methyl chloride quaternary salt; dimethylaminoethylmethacrylate methyl chloride quaternary salt; and dimethylaminoethylacrylate benzyl chloride quaternary salt (DMAEA.BCQ)

In another embodiment, the dosage of cationic polymers is from about 0.1 ppm to about 1000 ppm active solids

In another embodiment, the cationic polymers have a cationic charge of at least 2 mole percent.

In another embodiment, the cationic polymers have a cationic charge of 100 mole percent.

In another embodiment, the cationic polymers have a molecular weight of about 2,000 to about 10,000,000 daltons.

In another embodiment, the cationic polymers have a molecular weight of about 20,000 to about 2,000,000 daltons.

In another embodiment, the zwitterionic polymers are composed of about 1 to about 99 mole percent of N,N-dimethyl-N-methacrylamidopropyl-N-(3-sulfopropyl)-ammonium betaine and about 99 to about 1 mole percent of one or more nonionic monomers.

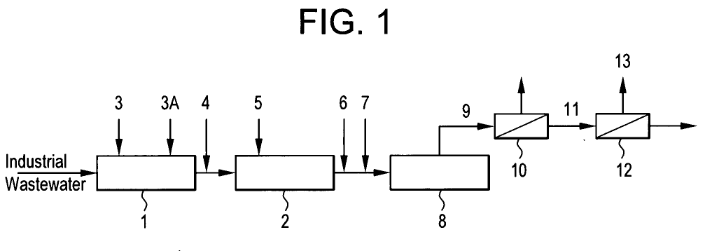

A potential industrial wastewater treatment scheme is shown in FIG. 1.

Referring to FIG. 1, industrial wastewater containing mercury is collected in a receptacle (1), in which acid or base is added through a line (3) to adjust pH to 3-4. The chelant scavenger such as an iron compound is then added through a line (3A). This water then flows in to a receptacle (2), in which the pH is adjusted to 8-10 through in-line (4) or direct (5) addition of base in the receptacle (2). After the pH adjustment, the polymeric chelant such as ethylene dichloride-ammonia polymer may be added in-line (6). After ethylene dichloride ammonia polymer is added, one or more water-soluble polymers may be added optionally in-line (7) before the water flows to a filter device (8). The filtrate (9) from the filter device may be optionally treated by passing it through a UF or MF membrane (10). The permeate (11) from UF or MF membrane may be further treated by an additional membrane (12) and the reject (concentrate) (13) from this system may be sent for further dewatering or disposal.

The following examples are not intended to limit the scope of the claimed invention.

### EXAMPLES

This invention was tested by conducting experiments with a 0.45-10 μm pore size syringe filter and industrial wastewater. Mercury concentration in the feed and filtrate was measured using Atomic Fluorescence Spectroscopy method (EPA Method # 1631).

### Example 1

A power plant scrubber wastewater containing 323 ppt of mercury was obtained from an Eastern US power plant and placed in a tank equipped with an overhead mixer. The pH was adjusted to 8.9 with 25% sodium hydroxide and a 100 ppm of ethylene dichloride-ammonia polymer, functionalized with carbon disulfide and available from Nalco Company, 1601 West Diehl Road, Naperville, Ill., was added and mixed for 30 minutes. After 30 minutes, 2 ppm of cationic polymer (copolymer of methyl chloride quaternized dimethyl aminoethyl acrylate and acrylamide copolymer with 50 mole % cationic charge) also available from Nalco Company, was added in the above treated wastewater and then mixed for 5 minutes. This treated wastewater was then filtered through 0.45 to 10 micron Millipore filter and then Hg level analyzed and compared with that in the scrubber wastewater. The results are shown in Table 1 below:

TABLE 1

| | Mercury Level |
|---|---|
| Treatment | (ppt) |
| Untreated wastewater | 323 |
| Treated as above and filtered through 10 micron filter | 318 |
| Treated as above and filtered through 5 micron filter | 20.2 |
| Treated as above and filtered through 1.2 micron filter | 25.3 |
| Treated as above and filtered through 0.45 micron filter | 15.5 |

### Example 2

A similar treatment protocol was used as in Example 1, but in this example, the power plant scrubber wastewater had 190 ppt mercury. This wastewater was also obtained from Eastern US power plant. In this example, 1.2 micron Millipore filter was used and the filtrate mercury level was 10.7 ppt.

### SUMMARY

Both examples show that with the method of this invention a dramatic reduction in mercury levels from power industry wastewater could be achieved to meet regulatory discharge limits.

1. A method of removing one or more heavy metals including mercury from industrial wastewater by use of a filtration process comprising the following steps:
a. maintaining the pH of said industrial wastewater to achieve at least the hydroxide precipitation of mercury;
b. adding an effective amount of a water soluble ethylene dichloride ammonia polymer having a molecular weight of from about 500 to about 10,000 daltons that contain from about 5 to about 50 mole percent of dithiocarbamate salt groups to react with at least mercury in said industrial wastewater;
c. passing said treated industrial wastewater through a filter device excluding a UF or MF membrane; and
d. optionally back-flushing said filter device to remove solids from the filter device.

2. The method of claim 1, wherein said effective amount of said water soluble ethylene dichloride ammonia polymer is from 10 ppm to about 1000 ppm based upon actives.

3. The method of claim 1 further comprising the step of: adjusting the pH of said industrial wastewater before step (a) to de-complex metals from one or more chelants, if present, in said industrial wastewater and subsequently or simultaneously adding one or more chelant scavengers, optionally wherein said pH adjustment before step (a) is to less than 4.

4. The method of claim 1 further comprising treating the industrial wastewater with one or more water-soluble polymers after step (b) and before passing through said filter device.

5. The method of claim 1, wherein said filter device has a separation rating in the range of 0.001 to 10 μm or 0.1 μm to 10 μm.

6. The method of claim 1, wherein the water soluble ethylene dichloride ammonia polymer has a molecular weight of about 2,000 to about 2,000,000 daltons.

7. The method of claim 4, wherein said water-soluble polymers are selected from a group consisting of: amphoteric polymers, cationic polymers, zwitterionic polymers, anionic polymers and a combination thereof.

8. The method of claim 7, wherein the amphoteric polymers are selected from the group consisting of: dimethylaminoethyl acrylate methyl chloride quaternary salt/acrylic acid copolymer, diallyldimethylammonium chloride/acrylic acid copolymer, dimethylaminoethyl acrylate methyl chloride salt/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer and DMAFA.MCQ/Acrylic acid/N,N-dimethyl-N-methacrylamidopropyl-N-(3-sulfopropyl)-ammonium betaine terpolymer.

9. The method of claim 7, wherein the dosage of the amphoteric polymers are from about 1 ppm to about 2000 ppm of active solids, or wherein the amphoteric polymers have a molecular weight of about 5,000 to about 2,000,000 daltons.

10. The method of claim 7, wherein the amphoteric polymers have a cationic mole charge equivalent to an anionic mole charge equivalent ratio of about 3.0:7.0 to about 9.8:0.2.

11. The method of claim 7, wherein the cationic polymers are selected from the group consisting of: polydiallyldimethylammonium chloride; polyethyleneimine; polyepiamine; polyepiamine crosslinked with ammonia or ethylenediamine; condensation polymer of ethylenedichloride and ammonia; condensation polymer of triethanolamine and tall oil fatty acid; poly(dimethylaminoethylmethacrylate sulfuric acid salt); and poly(dimethylaminoethylacrylate methyl chloride quaternary salt).

12. The method of claim 7, wherein the cationic polymers are copolymers of acrylamide and one or more cationic monomers selected from the group consisting of: diallyldimethylammonium chloride, dimethylaminoethylacrylate methyl chloride quaternary salt, dimethylaminoethylmethacrylate methyl chloride quaternary salt and dimethylaminoethylacrylate benzyl chloride quaternary salt.

13. The method of claim 7, wherein the dosage of cationic polymers is from about 0.1 ppm to about 1000 ppm active solids.

14. The method of claim 7, wherein the cationic polymers have a cationic charge of at least about 2 mole percent.

15. The method of claim 7, wherein the cationic polymers have a cationic charge of 100 mole percent.

16. The method of claim 7, wherein the cationic polymers have a molecular weight of about 2,000 to about 10,000,000 daltons or from about 20,000 to 2,000,000 daltons.

17. The method of claim 7, wherein the zwitterionic polymers are composed of about 1 to about 99 mole percent of N,N-dimethyl-N-methacrylamidopropyl-N-(3-sulfopropyl)-ammonium betaine and about 99 to about 1 mole percent of one or more nonionic monomers.

18. The method of claim 1, wherein the filter device is selected from the group consisting of: a single media filter, a bag filter, a sand filter, a multimedia filter, a cartridge filter, a diatomaceous filter, a drum filter with a coated media, a drum filter with a coated media containing diatomaceous earth, and a combination thereof.

19. The method of claim 1 further comprising: passing a filtrate from said filter device through an ultrafiltration or a microfiltration membrane, and optionally wherein filtrate from said ultrafiltration or microfiltration membrane is passed through an additional membrane, wherein said additional membrane is a nanofiltration membrane or a reverse osmosis membrane.

20. The method of claim 1, wherein the said industrial wastewater is from an industrial process selected from the group consisting of: power generation, semiconductor manufacturing, circuit board manufacturing, metal finishing, metal plating, refining, and automotive.

21. A method of removing one or more heavy metals including mercury from industrial wastewater by use of a solid-liquid separation process comprising the following steps:
a. maintaining the pH of said industrial wastewater to achieve at least the hydroxide precipitation of mercury;
b. adding an effective amount of a water soluble ethylene dichloride ammonia polymer having a molecular weight of from about 500 to about 10,000 daltons that contain from about 5 to about 50 mole percent of dithiocarbamate salt groups to react with at least mercury in said industrial wastewater; and
c. passing said treated industrial wastewater through a solid liquid-separation device, excluding a UF or MF membrane, and
d. optionally passing said industrial wastewater from step c) through one or more additional solid liquid-separation devices, optionally wherein said solid liquid-separation devices are selected from the group consisting of: a UF or a MF membrane.

22. The method of claim 21, wherein said solid-liquid separation device is selected from the group consisting of: a centrifuge, a lamellae plate clarifier, or a combination thereof.

23. The method of claim 21 further comprising: passing a filtrate from said solid liquid separation device through an ultrafiltration or a microfiltration membrane, and optionally wherein filtrate from said ultrafiltration or microfiltration membrane is passed through an additional membrane, wherein said additional membrane is a nanofiltration membrane or a reverse osmosis membrane.
